(19) United States
(12) Patent Application Publication
(10) Pub. No.: US 2008/0285429 A1
(43) Pub. Date: Nov. 20, 2008

(54) Side-Channel for Record Carriers with Spiral Tracks

(75) Inventors: Johan Cornelis Talstra, Eindhoven (NL); Antonius Hermanus Maria Akkermans, Eindhoven (NL); Adrianus Johannes Maria Denissen, Eindhoven (NL); Nicolaas Lambert, Eindhoven (NL); Antonius Adriaan Maria Staring, Eindhoven (NL); Jan Harm De Boer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/581,134

(22) PCT Filed: Nov. 25, 2004
(86) PCT No.: PCT/IB04/52545

§ 371 Date: May 30, 2006

(30) Foreign Application Priority Data
Dec. 3, 2003 (EP) 03104509.9

(51) Int. Cl. G11B 7/24

(52) U.S. Cl. 369/275.3

(57) ABSTRACT

In order to create a record carrier having a side-channel which cannot be copied with a channel-bit recorder, the record carrier (1) has a modulated spiral. By modulating one or more of the spiral parameters, like the channel bit length or the track pitch, a side-channel is created. If a record carrier having such a side-channel is copied using a channel-bit recorder, the information present in the side-channel is lost. The number of bits to be stored in the modulated spiral can be selected as desired; also the way in which the bits are present can be selected; the bits can e.g. can be stored in different bands (A,B,C,D) present on the record carrier, in which band the spiral parameter modulated can be kept constant.

The invention relates to a record carrier.

For over 20 years now, commercial software for PCs or PC-like platforms like MS XBox, Sony PlayStation, Sega DreamCast, Nintendo GameCube has been distributed on cheap, easy to reproduce media: first floppy discs, and more recently optical media. There are many methods, known from prior art, to protect this software from being copied illegally, e.g. dongles, running on remote servers etc. However the cheapest, and most widely used method is to alter the distribution media in such a way that this alteration cannot be reproduced (easily) in writers available to the public. The alteration should be detectable using ordinary playback-drives. Examples are: holes in the physical media (manifests themselves through error bursts in pre-determined locations), intentional errors in ECC-parities, (manifests themselves through error bursts in pre-determined locations), data written to lead-in sectors on DVD (reading is supported on DVD-ROM drives, but writing not generally on DVD-writers), essential data written in other sub-channels (like the sub-channels R-W of a CD), optical discs with multiple sessions which are not written according to specification (presumably a writer can only write data according to specifications). These alterations are sometimes referred to collectively as ROM side-channels.

Upon execution, the software present in the PC or PC-like platform checks whether the required alteration is present on the media, and if not, it terminates because presumably it was running from an illegal copy.

This system is vulnerable to different types of threat. A first threat is that the check which the PC or PC-like platform performs is normally implemented as an “if”—statement in software, which may be discovered by a hacker, and disabled or circumvented. The program will then also run without the original media. Alternatively, the hacker may add extra modules (drivers) to the operating system in order to spoof the program by simulating the original media (e.g. return errors rather than correct data for the predefined locations above). These kind of hacks can be prevented by tamper-proofing the software: encryption and execution-obfuscation are often used techniques.

A second threat is that, given the consumer demand for recorders/writers that can copy anything, including protected software, some recorder-manufacturers regularly enhance their recorders with extra circuitry or firmware to enable writing the previously uncopy-able alterations. So called RAW-mode and DAO/SAO drives are examples of this development.

In other to overcome the first threat, a veritable copy-protection industry has sprung up with companies such as Macrovision (SafeDisc) and SunComm (SecuROM). These companies bring to the market updates of their current software tamper-proofing methods. Although these updates are usually also hacked within a year of their appearance, this time-to-market advantage apparently provides the software companies, such as games-producers, enough revenue to warrant continued protection of their games.

The second threat is equally serious as this is in effect an arms race between software-protection companies and drive manufacturers. The ROM side-channels currently used can be defeated quite easily with a writer which can write every individual bit on the disc, a so-called channel-bit recorder. Although currently not available to consumers, such a channel-bit recorder is technically feasible, no more expensive than current writers, and has appeared already in the professional market. Although one might be able to come up with a ROM side-channel that could not be copied by such a channel-bit recorder, the detection of such a ROM side-channel still required a dedicated drive for detection it. This is commercially unacceptable for at least PC-software.

Instead of using these ROM side-channels for copy protection purposes, some copy protection mechanisms exist which use the physical properties of optical discs. For example, U.S. Pat. No. 6,560,176 discloses a copy protection mechanism which is based on measuring, on a CD, the relative angular orientation of specific non-reflective areas on the CD. In this mechanism, the fact that CDs manufactured from the same master will have distinctive physical characteristics in common, among others the relative angular orientation of the specific non-reflective areas, is used as an identification of the source. Illegal copying is prevented, by comparing the orientation of an original CD with the measured orientation of an alleged pirate copy. A CD protected using this copy protection mechanism has as a disadvantage that these relative angular orientations are not known before the disc is actually manufactured. It is therefore for example impossible to have a computer program stored on that same disc which can check for the presence of the correct angular orientations.

It is an object of the invention to create a record carrier comprising a side-channel, which record carrier cannot be copied with a channel-bit recorder.

The object of the invention is realized by a record carrier comprising a predetermined spiral which spiral can be described using parameters, the record carrier further comprising a side-channel encoded by the parameters being modulated in a pre-determined way. By modulating the parameters describing the spiral in a pre-determined way, a side-channel is created. If a record carrier having such a side-channel is copied using a channel-bit recorder, the information present in the side-channel is lost. This record carrier has thus as an advantage that, unlike most existing record carriers storing computer games, it cannot be copied using a channel bit recorder. Further, it has as an advantage that the record carrier is backwards-compatible and can thus be used in existing drives, e.g. DVD-ROM drives.

In an embodiment of the information carrier according to the invention, the predetermined spiral is for storing information in sectors, the sectors being addressable with bit-addresses l, where the relation between the bit-addresses, their polar co-ordinates and the parameters describing the spiral are approximately given by the following formula:

$$\{ \begin{matrix}r = \frac{{D}_{tb}}{2 π} Φ \\ ϕ = Φ mod 2 π\end{matrix} , Φ = \sqrt{\frac{4 π {L}_{cb}}{{D}_{tb}} + {l ( {Φ}_{0} )}^{2}}$$

where r and φ are polar co-ordinates, Φ is the cumulative angle, L_{cb} is the channel-bit length, Dₜₚ is the trackpitch and Φ₀ is the angle at which the first bit on the spiral is written, and 1 is the bit-address of a sector. The formula gives a good estimation for the spiral as is used on optical discs like DVD-Video discs or DVD+RW discs. The information on such discs is addressable using the presence on the discs of addresses associated to the different sectors in which the information is stored (in case of pre-recorded discs) or to be stored (in case of recordable discs).

Different parameters describing of the spiral can be used for creating the side-channel. A suitable parameter is the channel bit length; advantageously the channel bit length in a first area has a different value than the channel bit length in another, second area, the channel bit length is modulated into different bands on the record carrier, or is constant within a band. In particular bits forming the side-channel are encoded in the parameters modulated in each band. By modulating the channel bit length accordingly, a secure side-channel (i.e. a side-channel which cannot be copied by a channel-bit recorder and also it cannot be detected using a normal drive) is created. Another parameter which can be used for creating the side-channel is the trackpitch.

Preferably, the record carrier adheres to a certain standard specification, wherein the parameters modulated adhere to the requirements on the parameters according to the standard specification. This means that only minor modifications to the parameters describing the spiral are introduced, so that they still adhere to the standard specification requirements. This has the advantage that drives adhering to this standard specification should also be able to read and/or write on this embodiment of a record carrier according to the invention. It further has the advantage the minor modifications are more difficult to detect by hackers.

One interesting application for the record carrier according to the invention is to use it in an information access and/or copy protection system, where the side-channel is used to distinguish a read-only record carrier from recordable and rewritable record carriers. Such record carriers can for example be used for the protection of PC-software games or for realizing a secure distribution of audio/video information using current hardware. The detecting or not detecting of the expected side-channel can also be used for determining the originality of the record carrier.

In addition to the modified spiral, in a further embodiment, the record carrier comprises a computer program comprising software for detecting the side-channel and possibly also spiral information, wherein the software is also arranged for comparing the side-channel detected with the spiral information. The inclusion of the spiral information on the record carrier has as an advantage that, as the spiral can normally be only characterized afterwards, the results of this characterization can be entered into the software program which verifies it against the disc from which it is running. The integrity check can thus be fully contained on the disc without the need for external contact, or key-number information from a label to be entered by the user.

These and other aspects of the invention will be apparent from and elucidated with reference to the embodiments described hereinafter.

In the drawings:

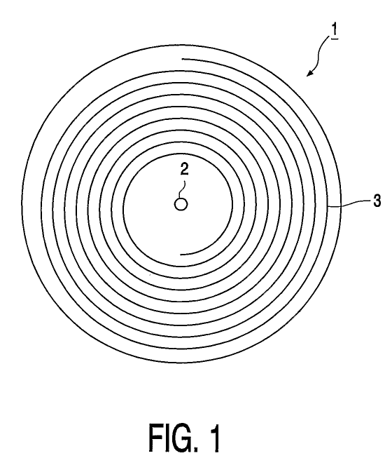

FIG. 1 shows an embodiment of the record carrier according to the invention,

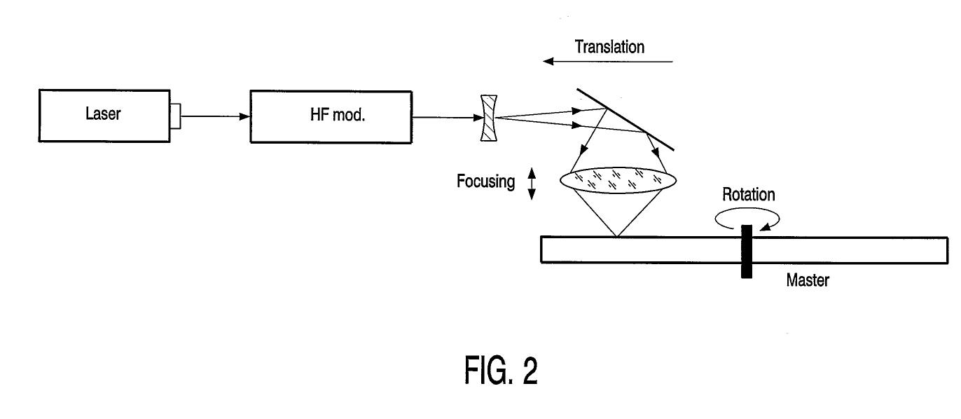

FIG. 2 shows a schematic diagram of a laser beam recorder used for mastering,

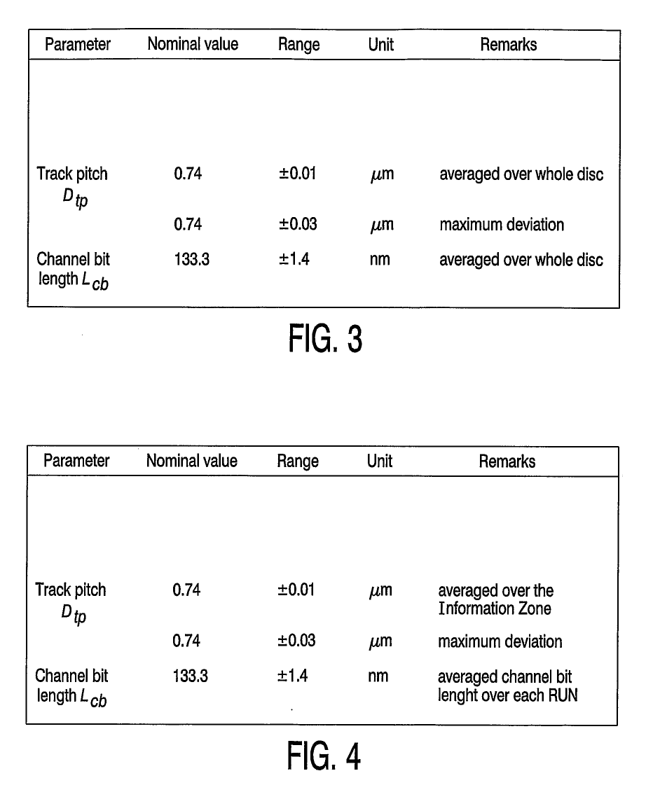

FIGS. 3 and 4 show the parameter tolerances for a DVD-RW disc and a DVD+RW disc respectively,

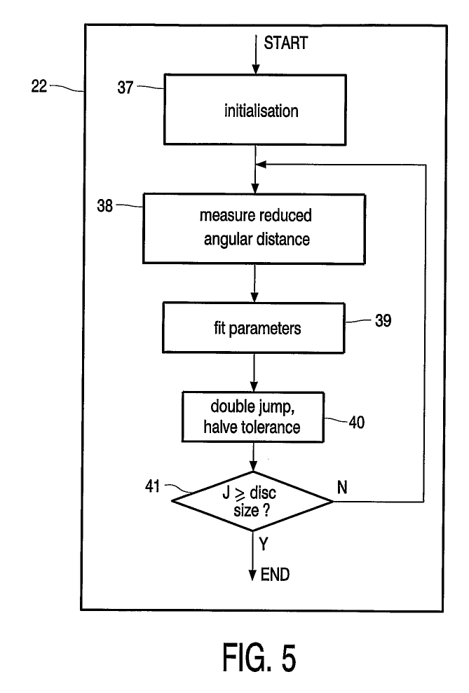

FIG. 5 shows a flow diagram of a particular embodiment for measuring the physical parameters of the record carrier according to the invention,

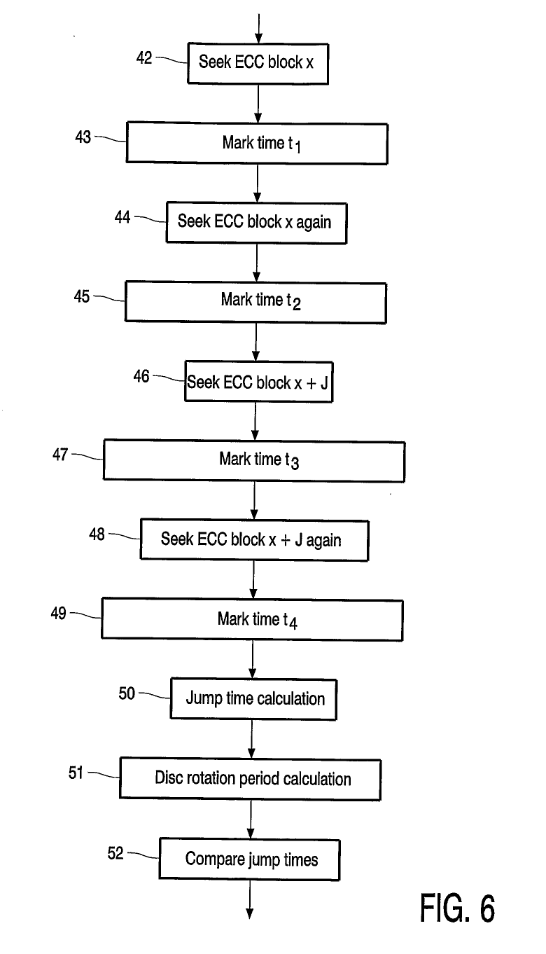

FIG. 6 shows a flow diagram of an embodiment in which the reduced angular distance measurements are based on timing measurements,

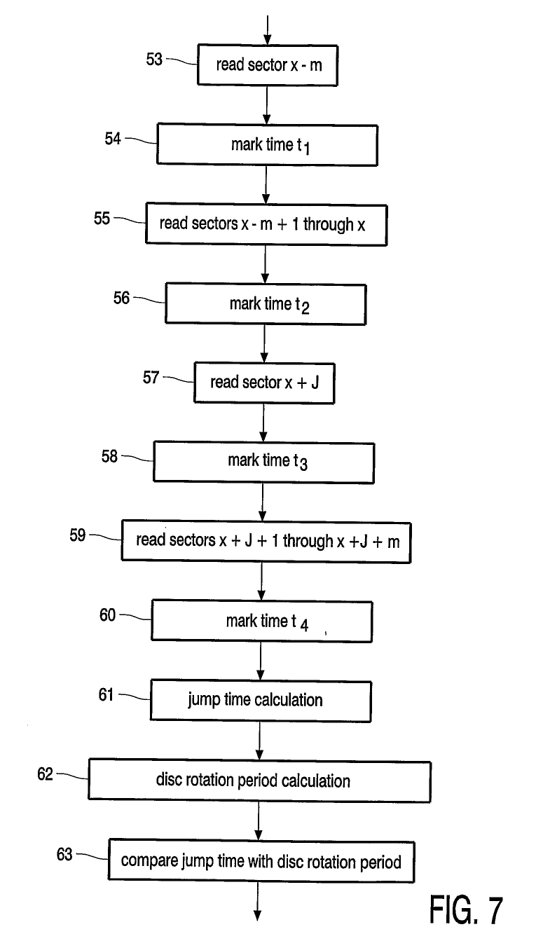

FIG. 7 shows a flow diagram of another embodiment in which the reduced angular distance measurements are based on timing measurements.

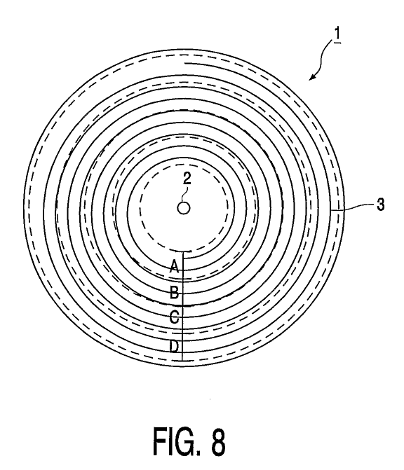

FIG. 8 shows an embodiment of a record carrier according to the invention in which the channel bit length is modulated into different bands,

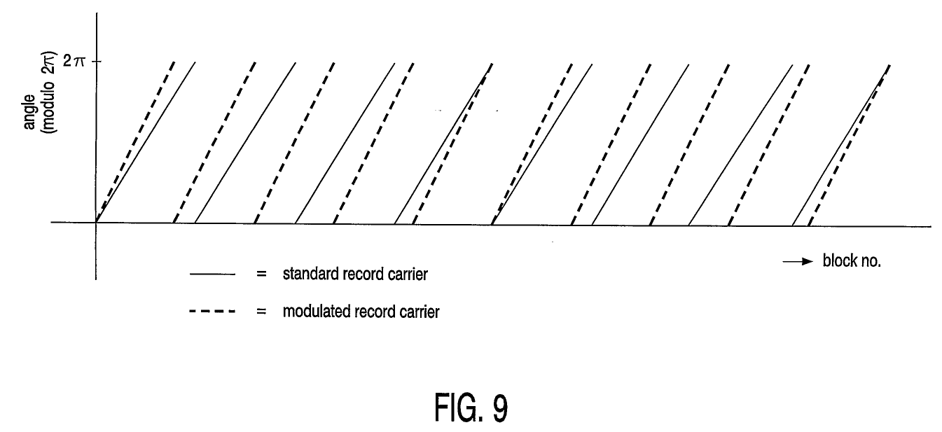

FIG. 9 shows the effect of the modulation of certain spiral parameters.

FIG. 1 shows an embodiment of the record carrier according to the invention. The record carrier 1 has a central aperture 2 and an information area 3. The record carrier 1 can be both of a read-only type (e.g. a DVD-Video disc), and of a recordable type (e.g. a DVD+RW disc). In this embodiment of the record carrier according to the invention, it is proposed to master the data on the original media using a trackpitch Dₜₚ and a channel-bit length L_{cb} which is slowly modulated in a pre-determined pattern. Mastering is the process of recording the data which is to be present on the original media, to a so called master or stamper. As the name indicates, the stamper is used to stamp the actual media, typically many 10,000 s. FIG. 2 shows a schematic diagram of a laser beam recorder used for mastering (source: Chapter 5 of “Principles of Optical Disc Systems”, Bouwhuis et al., Adam Hilger Ltd, 1986). In this Figure, it is depicted that the intensity of the focused laser beam is modulated in accordance with the information to be recorded on the master/stamper. In the areas of the master which are exposed to the laser beam, the photo resist on the master dissolves in the development stage. It is shown, that in this mastering process several degrees of freedom are present for steering the laser beam towards, e.g. by changing the focus of the laser beam or the position of the laser beam with respect to the master (translation, rotation). Using this freedom, a master can be created which has a trackpitch Dₜₚ and a channel-bit length L_{cb} which is modulated in a pre-determined way. This varying of parameters like Dₜₚ and L_{cb}, e.g. taking on different values in different small bands, is relatively easy in mastering equipment. Preferably, the values of Dₜₚ and L_{cb} should still be close to the values allowed by the media specification.

On many standardized types of recordable/rewritable discs the location of bits on a recordable/rewritable disc is (substantially) determined by the pregroove which yields a predefined trackpitch Dₜₚ and channel-bit length L_{cb} determined by the master of the recordable/rewritable disc. A writer writing to such disc cannot cause the bits to reside on a spiral with the same trackpitch and channel-bit length as the original disc. As is well known to a skilled person, the pregroove on an optical record carrier is a shallow spiral pre-embossed on the recordable/rewritable carrier, to allow addressing in the absence of written data, such as on a virgin disc; the data-bits are actually written in/next to this groove; usually the groove is modulated, e.g. using wobbles, headers and/or pre-pits, with address information which ultimately determines the location of the data-bits. Therefore this modulated spiral yields a side-channel which satisfies two criteria: 1. the side-channel is readable in legacy drives using the method of non pre-published Dutch patent application with application number 1021854 (PHNL021074 NL-P), 2. the side-channel cannot be written using current writers or future channel-bit recorders, and only with difficulty with professional equipment. This side-channel can be viewed as a combination of an extremely low frequency (<<1 Hz) radial wobble with an extremely low frequency tangential (channel-clock) wobble.

To access specific bits on the record carrier 1 using an existing drive one cannot use ordinary (X,Y) or (r,φ) co-ordinates, but one must use the so called physical bit address l. In essence the bit-address l is an integer denoting the address of the bit on the spiral along which the data is written. For a perfect spiral, in principle there is a simple formula between bit-address l and (r, φ) co-ordinates (small logarithmic corrections which are irrelevant for typical optical media (Dₜₚ<<rₘₐₓ, the maximum radius of 58 mm) are ignored in this formula):

$$\{ \begin{matrix}r = \frac{{D}_{tp}}{2 π} Φ \\ ϕ = Φ mod 2 π\end{matrix} , Φ = \sqrt{\frac{4 π {L}_{cb}}{t} + {l ( {Φ}_{0} )}^{2}}$$

where L_{cb} is the length of one channel-bit, Dₜₚ is the trackpitch (on an optical medium the track pitch is the distance between consecutive revolutions of the spiral on the disc) and (Do is the angle at which the first bit on the spiral is written (2.04×10⁵ rad for DVD). Typical values for the track pitch and the channel bit length are indicated in FIGS. 3 and 4, which show a table comprising parameter tolerances for a DVD-RW disc (FIG. 3) and for a DVD+RW disc (FIG. 4).

However the problem with this relation is that for larger values of l (i.e. further out on the disc) the equation for φ starts to exhibit chaotic behavior: any minute uncertainty in Dₜₚ, L_{cb} leads to drastic errors in φ (i.e. bits pixels appear at completely the wrong angle). In order to write an image to mm accuracy, the values of Dₜₚ and L_{cb} have to be known to at least 1 part in 10⁻⁷! There are two problems which deteriorate this: 1. because the DVD-specifications only fix Dₜₚ and L_{cb} to within ˜1%, every disc (see FIGS. 3 and 4), or at least discs from different masters are different; so each disc must first be characterized by measurements to fix its values of Dₜₚ and L_{cb}; 2. although good enough for most purposes, the simple spiral model is not completely adequate. Higher order corrections are necessary to describe the mapping more accurately.

In the non pre-published Dutch patent application with application number 1021854 (PHNL021074 NL-P) a method to predict very precisely (with an accuracy of 1 micron or less) where every information bit on a recordable optical disc will be written is described. This method can be used by existing PC based recorders. Using this method, the parameters Dₜₚ and L_{cb} can be determined to the necessary accuracy, on legacy DVD-drives under the assumption that the drive operates in CAV mode. CAV=Constant Angular Velocity, this means that in this mode the drive does not change its angular speed while accessing the disc, implying that the actual bit rate depends on the exact radius where access is taking place, because larger radii can contain more bits; in contrast to the CLV mode, CLV=Constant Linear Velocity, which mode implies that the drive adapts the angular speed such that the number of bits/sec. accessed is constant. An insight is that the time-delay between reading from two different bit-addresses on the disc is a direct measure for the angle (mod 2π) between the bit-location of the first and the second bit-address, largely independent of PC, drive and Operating System (OS).

In order to know where the channel bits end-up on the information area 3, it is necessary to analyze the way a standardized record carrier is defined. Recordable and rewritable media are mastered with a groove and sector address indication (e.g. in the rewritable DVD+RW disc a wobbling groove is used for sector address indication; in the recordable DVD-R disc pre-pit information relating to the sector address is present in the land area). The standard specification for these media generally prescribes the physical layout in terms of inner radius R₀, track pitch Dₜₚ and channel bit length L_{cb}, but does not define the details of the disc mastering. The inner radius R₀ is the radius on a record carrier at which the information area begins. The information area normally comprises three areas, the lead-in area, a data recording area and a lead-out area. The track pitch Dₜₚ is the distance between adjacent tracks measured in the radial direction. The channel bit length L_{cb} is the unit length T of a channel bit. For example in DVD, the minimum recording pit length is equal to three times the channel bit length, 3T, and the maximum recording pit length is equal to eleven times the channel bit length, 11T. Given these parameters, however, it is in principle possible to deduce the entire mapping of the channel bits over the record carrier, if it is assumed that the data density is exactly uniform over the disc, i.e. a spiral with perfectly constant track pitch Dₜₚ and channel bit length L_{cb}, and that starts exactly at inner radius R₀. For a spiral, the radius r grows with a single track pitch Dₜₚ for every revolution, so r simply depends linearly on the cumulative angle Φ:

r(Φ)=R₀+DₜₚΦ/2π

By integrating along the track length, we find the relation between bit string position l and the cumulative angle Φ:

lL_{cb}=∂r(Φ)dΦ=∂(R₀+DₜₚΦ/2π)dΦ=R₀+DₜₚΦ²/4π

Solving for Φ yields:

Φ(l)=2π{√(lL_{cb}Dₜₚ/π+R₀²)−R₀}/Dₜₚ

and

r(l)=√(lL_{cb}Dₜₚ/π+R₀²)

The problem is that the inner radius R₀, track pitch Dₜₚ and channel bit length L_{cb} are known only to a certain precision (see FIGS. 3 and 4). For the radius r(l) this is not always a problem, as the specified precision is sufficient for most practical purposes. Small relative errors in Φ(l), however, give rise to disastrous errors in the reduced angle φ:

φ(l)=Φ(l) mod 2π.

A DVD disc for example uses more than 40.000 revolutions from the inner radius to the outer radius. Hence a relative error of 1% in Φ(l) corresponds to more than 40000% error in φ(l): a 1% error in Φ(l) causes the label image to be rotationally warped over more than 400 revolutions. The problem is that a very minor miscalculation of the data length per revolution accumulates to a large error after 40000 revolutions.

Closer inspection of the equation for Φ(l) shows that the three constants R₀, Dₜₚ and L_{cb} result in only two media master specific parameters A and B:

Φ(l)=√(Al+B²)−B

with

A=4πL_{cb}/Dₜₚ

B=2πR₀/Dₜₚ

A more intuitive explanation for a two parameter description is that the linear spiral can be defined by the amount of data that is written in the first revolution of the track, and the fixed growth of that amount per revolution (this leaves the scale of the spiral as a third parameter, but the scale does not affect the rotational warp and therefore does not have to be known at great precision). This simple two parameter problem can give rise to rather spectacular but undesirable warp patterns when the parameters are slightly off. Experiments showed that several iterations in the visual calibration procedure are needed to achieve the required sub-ppm precision in A and B for less than 1 mm distortion in the visible label. It was found that the result of the two parameter iterative fit procedure is not only reproducible within one disc, but even between several rewritable discs bought in a single pack. Apparently discs from a single batch tend to come from a single master template.

As said before, in order to write a visible image on the disk, it is crucial to know exactly where written data end up on the disc area. After all, we want to write visible image pixels in a 2-dimensionally coordinated way. In the already mentioned non pre-published Dutch patent application with application number 1021854 (PHNL021074 NL-P) different embodiments for measuring the physical parameters of the record carrier are described. The parameters can be retrieved by performing measurements on the record carrier, for example angle measurements, in particular angular distance measurements. The information on the physical parameter can than be retrieved by fitting the acquired data to the angular distance measurements. These angular distance measurements can be based on tacho information or on timing measurements. Also the eccentricity of the record carrier can be determined so that the angular distance measurements can be based on the eccentricity.

FIG. 5 shows a flow diagram of a particular embodiment for measuring the physical parameters of the record carrier. In this embodiment the physical parameters are retrieved from reduced angular distance measurements. Angular distance between two sectors is defined here as the spiral angle between the two sector headers, in other words the angle between the two physical sector header locations viewed from the center of the disc. The term “reduced” is used here to indicate an angle between 0 and a full revolution, disregarding any additional spiral revolutions along the spiral track between the two sectors. The term “cumulative” on the other hand includes all those spiral revolutions. In this embodiment, initial model parameters, a parameter tolerance window and a jump distance are used, depicted in block 37. These parameters are such that the model predicts the angular distance for the jumps with better than half a revolution accuracy. This permits reliable fitting to the reduced angular distance measurements, because local optima corresponding to one or more revolutions of mismatch are avoided. In step 38, the reduced angular distance for a number of jumps scattered over the disc area are measured and suspect measurements are discarded. In step 39, the physical parameters are fitted within the parameter tolerance window to these measurements. This fit results in more accurate information on the physical parameters (e.g. the track pitch or the channel bit length). For each successive iterative loop, the jump distance is doubled and the tolerance window is halved, step 40, keeping the next fit again reliably restricted to the global optimum. The method is ended in the case the jump distance J exceeds disc size, step 41. The values of the physical parameters thus acquired can be used for writing the label on the record carrier. Depending on the accuracy and number of measurements, it may take up to a few minutes to execute sufficient iterations. The reduced angular distance measurements can be based on tacho information, or on timing measurements. Timing measurements are explained further with reference to FIG. 6 and FIG. 7.

FIG. 6 shows a flow diagram of such an embodiment in which the reduced angular distance measurements are based on timing measurements. In this method the reduced angular distance between two ECC blocks is obtained through timing measurements. A possible implementation of the measurement procedure is depicted in block 38 in FIG. 5. The jump time between the two ECC blocks Tⱼₘₚ is measured and compared in modulo fashion with the disc rotation period Tᵣₒₜ. The disc rotation period Tᵣₒₜ is measured by accessing the same ECC block twice, for both ECC block x and ECC block x+J, and taking the average. The time marks can reference the moment that the ECC block header passes by inside the drive, or the finish of a successful uncached read request. In the last case, the measured angle corresponds in fact to the end of the sectors, i.e. the start of the next sector. Since the method uses time differences, it is insensitive to constant service delays. In practice, the accuracy of this method is only limited by the reproducibility of the service time of the disc drive. In detail this method is performed as follows. In step 42, ECC block x is sought. In step 43, time t₁ when ECC block x passes by is marked. In step 44, ECC block x is sought again. In step 45, time t₂ when ECC block x passes by is marked. In step 46, ECC block x+J, J being the jump distance, is sought. In step 47, time t₃ when ECC block x+J passes by is marked. In step 48, ECC block x+J is sought again. In step 49, time t₄ when ECC block x+J passes by is marked. In step 50, the jump time Tⱼₘₚ is calculated from the difference between t₃ and t₂. In step 51, the disc rotation period Tᵣₒₜ is calculated from ((t₂−t₁)+(t₄−t₃))/2. In step 52 finally, the jump time between ECC block x and ECC block x+J is compared in modulo fashion with the disc rotation period Tᵣₒₜ.

FIG. 7 shows a flow diagram of another embodiment in which the reduced angular distance measurements are based on timing measurements. In this method reading the same ECC block twice is avoided, and the method thus avoids read caching. Parameter m is a small integer constant, e.g. m=8. The disc model provides estimated angular size ΔΦₓ of ECC block x and ΔΦ_{x+J} of ECC block x+D. Disc rotation period is now derived by reading m contiguous ECC blocks and division by the estimated angular size of ECC blocks as provided by model. The time marks reference the finish of a successful read request. It is important that the time needed to read m sectors (t₂−t₁ and t₄−t₃) corresponds to the actual media read-out: interface speed must not be limiting. In detail, this method is performed as follows. In step 53, sector x-m is read. In step 54, time t1 when finished reading this sector is marked. In step 55, sectors x−m+1 through x are read. In step 56, time t2 when finished reading sector x is marked. In step 57, sector x+J is read. In step 58, time t3 when finished reading this sector is marked. In step 59, sectors x+J+1 through x+J+m are read. In step 60, time t4 when finished reading sector x+J+m is marked. In step 61, the jump time Tⱼₘₚ is calculated from the difference between t₃ and t₂. In step 62, the disc rotation period Tᵣₒₜ is calculated. In step 63 finally, the jump time is compared in modulo fashion with the disc rotation period Tᵣₒₜ. In the non pre-published Dutch patent application with application number 1021854 (PHNL021074 NL-P) additional background information on these embodiments is described.

Prior art methods for determining the originality of a disc by detecting wobbles require attaching some detector to the servo circuitry which attempts to track such modulations. For detecting the side-channel on the record carrier according to the invention, no special wobble detection circuitry is required.

Two ways for applying this to software protection are: 1) at start-up the protected software measures some properties of the spiral on the disc in the drive, and then compares these values to some values securely encoded inside that same program. If the match fails, the program aborts. This is a so called “decision based” copy protection measure: an “if”-statement as part of the control flow; 2) at start-up the protected software measures some properties of the spiral on the disc in the drive and then extracts bits from these measurements. These bits are used as part of some cryptographic procedure to continue execution, e.g. to unscramble the next module of the program. Although more secure, in it also requires a much higher degree of robustness of the information retrieved from the spiral: small errors completely prevent execution.

It must be noted that accurate estimation of spiral parameters is a time- and computation-intensive process as many jumps have to be made to collect information on the disc, and then the data has to be processed to high accuracy to yield accurate disc-parameter estimates. However for the purpose of this invention a very high accuracy is not always required. In essence it is sufficient when the probability of a rewritable/recordable disc to yield the same Dₜₚ and L_{cb} as an original disc to be negligible, say 1:1000 (so a hacker has to make copies on 500 different discs on average before one works). I.e. only about 10 bits of information need to be encoded in the description of the spiral. E.g. the spiral could have a fixed Dₜₚ and L_{cb} for, say, 5 bands, which would work if Dₜₚ and L_{cb} yielded 2 bits in every band. Lower required accuracy implies fewer measurements and less computation. In FIG. 8 such a record carrier according to the invention is shown. In this record carrier 1 the channel bit length is modulated in different bands A, B, C, D. Each band is situated in a certain distance interval with respect to the center of the record carrier. In each band the channel bit length is modulated so that it has in a certain band a value different from the channel bit length in another band (this is not depicted in FIG. 8). From the modulations in the different bands the encoded side-channel is extracted.

The effect of the modulation of certain spiral parameters is schematically depicted in FIG. 9. This Figure shows the relation between the constantly ascending block number on a record carrier and the angular position (modulo 2π) of these blocks on the record carrier; this relation is indicated for both an standard record carrier (e.g. a DVD+RW disc with the parameter tolerances as indicated in FIG. 4) and for a record carrier for which one or more of the spiral parameters is modulated. It can be seen that the angular position of a certain block on a modulated record carrier quickly deviates from the angular position of the same block on a standard, non-modulated record carrier. Using the angular distance measurements as explained with reference to FIGS. 5, 6 and 7, the modulated record carrier can easily be discerned from the non-modulated record carrier, and the corresponding bits of the side-channel can be deduced from the modulations present.

It must be noted that although physically the spiral is fixed by parameters like Dₜₚ an L_{cb}, it is equally so by the relative angular displacements (mod 2π) of a predefined set of bit-addresses. There is a one-to-one mapping between these angular displacements and the disc parameters, but the former are easy to measure, whereas the latter must be computed. It may be advantageous to characterize the disc/extract the bits from just these angular displacements or easily computable functions thereof.

Although the invention has been elucidated with reference to the embodiments described above, it will be evident that other embodiments may be alternatively used to achieve the same object. The scope of the invention is therefore not limited to the embodiments described above, but can also be applied to other kinds of record carriers, such as, for example, magnetical record carriers, optical-magnetical record carriers. The scope of the invention is also not limited to these kind of more or less conventional record carriers, but can also be applied to so-called 2D optical record carriers, where the information stored has a 2D character in that the bits forming the information are organized in a broad spiral consisting of a number of bit-rows stacked upon each other with a fixed phase relation in the radial direction, so that the bits are arranged on a 2D lattice.

It should further be noted that use of the verb “comprises/comprising” and its conjugations in this specification, including the claims, is understood to specify the presence of stated features, integers, steps or components, but does not exclude the presence or addition of one or more other features, integers, steps, components or groups thereof. It should also be noted that the indefinite article “a” or “an” preceding an element in a claim does not exclude the presence of a plurality of such elements. Moreover, any reference sign does not limit the scope of the claims; the invention can be implemented by means of both hardware and software, and several “means” may be represented by the same item of hardware. Furthermore, the invention resides in each and every novel feature or combination of features.

The invention can be summarized as follows: In order to create a record carrier having a side-channel which cannot be copied with a channel-bit recorder, the record carrier (1) has a modulated spiral. By modulating one or more of the spiral parameters, like the channel bit length or the track pitch, a side-channel is created. If a record carrier having such a side-channel is copied using a channel-bit recorder, the information present in the side-channel is lost. The number of bits to be stored in the modulated spiral can be selected as desired; also the way in which the bits are present can be selected; the bits can e.g. can be stored in different bands (A,B,C,D) present on the record carrier, in which band the spiral parameter modulated can be kept constant.

1. Record carrier (1) comprising a predetermined spiral which spiral can be described using parameters, the record carrier further comprising a side-channel encoded by the parameters being modulated in a pre-determined way.

2. Record carrier as claimed in claim 1, wherein the predetermined spiral is for storing information in sectors, the sectors being addressable with bit-addresses, the relation between the bit-addresses and the parameters describing the spiral approximately given by the following formula:
$$\{ \begin{matrix}r = \frac{{D}_{tp}}{2 π} Φ \\ ϕ = Φ mod 2 π\end{matrix} , Φ = \sqrt{\frac{4 π {L}_{cb}}{{D}_{tp}} l + {( {Φ}_{0} )}^{2}}$$
where r and φ are polar co-ordinates, Φ is the cumulative angle, L_{cb} is the channel-bit length, Dₜₚ is the trackpitch, Φ₀ is the angle at which the first bit on the spiral is written, and l is the bit-address of a sector.

3. Record carrier as claimed in claim 1, wherein the parameter modulated is the channel bit length.

4. Record carrier as claimed in claim 3, wherein the channel bit length in a first area has a different value than the channel bit length in another, second area.

5. Record carrier as claimed in claim 3, wherein the channel bit length is modulated into different bands (A,B,C,D) on the record carrier,

6. Record carrier as claimed in claim 5, wherein the channel bit length modulated is constant within a band.

7. Record carrier as claimed in claim 5, wherein bits forming the side-channel are encoded in the parameters modulated in each band.

8. Record carrier as claimed in claim 1, wherein the parameter modulated is the trackpitch.

9. Record carrier as claimed in claim 1, where the record carrier adheres to a certain standard specification, wherein the parameters modulated adhere to the requirements on the parameters according to the standard specification.

10. Record carrier as claimed in claim 1, wherein the side-channel is used in an information access and/or copy protection system.

11. Record carrier as claimed in claim 1, wherein the side-channel is used to distinguish a read-only record carrier from recordable and rewritable record carriers.

12. Record carrier as claimed in claim 1, wherein the record carrier further comprises a computer program comprising software for detecting the side-channel.

13. Record carrier as claimed in claim 12, where the record carrier further comprises spiral information, wherein the software is also arranged for comparing the side-channel detected with the spiral information.
